(19) United States
(12) Patent Application Publication
(10) Pub. No.: US 2026/0317961 A1
(43) Pub. Date: Oct. 15, 2026

(54) Integrated Textile Recycling and Spinning Machine

(71) Applicant: Säntis Textiles AG, Bühler (CH)

(72) Inventors: Stefan HUTTER, Bühler (CH); Laszlo OLAH, Au SG (CH); Resul ISTREFI, Au SG (CH)

(73) Assignee: Säntis Textiles AG, Bühler (CH)

(21) Appl. No.: 19/484,869

(22) PCT Filed: May 22, 2024
(86) PCT No.: PCT/EP2024/064094

§ 371 Date: Nov. 16, 2025

(30) Foreign Application Priority Data
May 22, 2023 (CH) CH000542/2023

(51) Int. Cl. D01G 11/00; D01G 5/00; D01H 1/14

(52) U.S. Cl. CPC D01G 11/00; D01G 5/00; D01H 1/14

(57) ABSTRACT

The present disclosure relates to an integrated recycling and spinning machine (300) and method for manufacturing yarn directly from textile waste, including: a recycling unit (301) that is configured to recycle textile waste material into recycled fiber material and is integrated with a drawing unit (302) and spinning unit (303) that are configured to manufacture a recycled fiber sliver and therefrom a yarn containing the recycled fiber material. The disclosure also relates to a method for integrated recycling and spinning of textile waste materials into a yarn by using the integrated recycling and spinning machine (300) as disclosed herein.

### CROSS REFERENCE TO RELATED APPLICATIONS

This application is a U.S. National Stage Application that claims priority to and the benefit of the filing date of International PCT Application No. PCT/EP2024/064094, filed on May 22, 2024, that claims priority to Swiss Application No. CH000542/2023, filed on May 22, 2023, each of which are hereby incorporated by reference in their entirety.

### FIELD OF THE INVENTION

The field of the invention are firstly recycling machines and recycling methods for recycling textile waste materials, and secondly spinning machines and spinning methods for reusing recycled textile fiber materials in a spinning process. The present invention broadly encompasses an integrated recycling and spinning device and an integrated recycling and spinning method based on waste textile materials. The invention more specifically relates to an integrated recycling and spinning machine, which provides integrated processes for obtaining and spinning recycled textile fiber material.

### BACKGROUND OF THE INVENTION

EP3845323 A1, published on Jul. 7, 2021 in the name of Kayren Joy Nunn, discloses an apparatus for deconstructing textile waste materials. In conventional recycling equipment, textile waste fabrics are torn by large-diameter tearing drums, which are run at high velocity and are typically not temperature-controlled, to form low-quality fibers which contain short and dusty fibrous material. As improvement, chemical or enzymatic treatment may be applied to the textile materials through nozzles and sucked through the textile materials by vacuum. The textile treatment may involve vapor, solution, dispersion or spray. The textile deconstruction involves rotating drums with cutting needles to achieve a desired level of deconstruction. Each rotating drum can be equipped inside with temperature controlling means to prevent temperature-induced fiber degradation. As shown in FIGS. 4-5, conveyor belts are used to transport the textile materials between treatment stations and deconstruction stations. A redeposit mechanism with suctioning means may be used to separate and output light-weight textile materials and further recycle heavy-weight textile materials. The downstream product may be transferred to an output storage box and, depending on treatment, may be used in healthcare, personal care, baby products or be subject to subsequent fiber refinement processing.

CN110004539 A, published on Jul. 12, 2019 in the name of University Jiangnan, discloses an environment-friendly pure yarn production method which includes the steps of: opening and combing air draft cotton and residual rough yarn ends collected in viscose fiber spinning by a mixing bale opener and a Kischner opener into single-fiber states; jointly and uniformly feeding single fibers and Lenzing viscose fibers treated by opening picking, beating the fibers into viscose rolls; sequentially performing cotton carding, double drawing, roving and spinning on the viscose rolls to prepare environment-friendly pure yarns.

CN110067057 A, published on Jul. 30, 2019 in the name of University Jiangnan, discloses a production method of an environment-friendly blended yarn. The method comprises the steps of: performing blowing and carding and pre-drawing on regenerated polyester fibers processed from a waste polyester material to prepare regenerated polyester strips; performing blowing and carding on cotton fibers to form cotton slivers; performing drawing for three times and mixing on the regenerated polyester strips and the cotton slivers to form mixed strips; and performing roving and spinning on the mixed strips to prepare the finally required environment-friendly blended yarn. The drawing involves specific steps, so that a mixing effect of the regenerated polyester fibers and the cotton fibers during the drawing is improved.

WO2020/152717, published on Jul. 30, 2020 in the name of Sharadha Terry Products Ltd., discloses a system and method for manufacturing textile products from roving waste material. The method serves for manufacturing 100% regenerated ring spun yarn out of waste generated during spinning, and additionally serves for manufacturing recycled ring spun yarn with cotton waste, comber noil and carding flat waste, which produces 100% cotton ring spun yarn.

EP1234900A1, published on Aug. 28, 2002 in the name of Maschinenfabrik Rieter AG, discloses a cleaning method and device to remove particulate impurities, such as plastic particles or other particles, from raw cotton fiber material.

U.S. Pat. No. 3,308,944 A, published on Mar. 14, 1967 in the name of Reclamation Trades Res Organis, discloses a separation of mixtures of textile fibres by electrostatic means. The separation process comprises dispersing the fibres in a stream of air and electrostatically charging them. Wool fibres in the dispersion may acquire a positive charge and polyester fibers a negative charge, both of sufficient magnitude for separation purposes. In the air stream, different rates of decay of like charges on different fibres can also be used to separate the fibres.

Thus, presently known textile recycling lines produce recycled textile fiber material for direct use e.g. in fleece materials, or alternatively for bale pressing and later use in a subsequent, separate spinning process. The subsequent, separate spinning process may use yarns recycled from textile waste material, from roving waste material or the like in combination with virgin yarns to produce recycled yarns of improved quality. The spinning process may involve rotor spinning or ring spinning.

### SUMMARY OF THE INVENTION

The object of the invention is to provide a device and method for simplified yarn manufacturing using fiber waste material. This object is achieved by the subject-matter set forth in the independent claims. Some embodiments are given in the dependent claims and claim combinations and provide further improvements.

The invention relates to an integrated recycling and spinning machine for manufacturing yarn from textile waste, in particular an integrated recycling and spinning machine for implementing the method for integrated recycling and spinning of textile waste materials into a yarn as disclosed herein, the machine comprising:
a. a recycling unit that is configured to recycle textile waste material into recycled fiber material, which is integrated with
b. a drawing unit and a spinning unit that are configured to manufacture a yarn containing the recycled fiber material.

The input products for the integrated recycling and spinning machine can be textile waste material, such as clothings and/or yarn waste material, that is typically provided in bales. The output product of the integrated recycling and spinning machine is yarn, which is typically wound in bobbins or cones for subsequent use in weaving, knitting or other fabrics-manufacturing machines. Herein, integrated means that the recycling, drawing and spinning units are combined into one machine or machine assembly in the same location, in particular are bodily connected and/or interlinked or arranged nearby one another in a manner such that immediate hand-over of intermediate fiber recycling products is possible between the manufacturing stages or steps. The intermediate fiber recycling products are not in form of bales.

The integrated recycling and spinning machine thus provides an integrated workflow from recycling textile waste material to a ready-to-use yarn product. This can create substantial advantages in logistics, production efficiency and production cost. In particular, this can be advantageous for textile waste recycling and yarn spinning in small lots. The invention can also involve coordinated operation of the recycling unit, drawing unit and spinning unit.

The textile waste material may include natural fiber, such as e.g. cotton, and also synthetic fiber, such as e.g. elastane, which may be extracted in the recycling unit. Also virgin natural fiber material may be admixed in the drafting and spinning unit to improve yarn quality.

The invention more specifically encompasses an integrated recycling and rotor spinning line, which avoids at least one of: the use of a separate recycling machine for obtaining recycled textile fiber material; a baling press associated with the recycling machine for pressing the recycled textile fiber material into bales; bales transportation means for transporting the bales of recycled textile fiber material to a separate location, in particular to a spinning mill; a bale opener for reopening the recycled textile fiber material; and a separate spinning machine for spinning recycled or mixed virgin and recycled textile fibers into yarn.

In embodiments, the recycling unit can comprise a cutter for cutting textile waste into pieces, a fiber opener line for pre-opening the textile fibers contained in the pieces, and at least one fine opener line for fine-opening the pre-opened textile fibers, all together for obtaining the recycled fiber material. The fine opening lines or stages allow for a soft opening process to obtain fibers for which a longer fiber length can be preserved. This has also the advantage that clothing waste, and also other waste such as yarn waste, can be used as input material in the integrated recycling, drawing and spinning process.

In embodiments of the integrated recycling and spinning machine, the recycling unit can comprise several fine opener lines in parallel, and some or all of the fine opener lines are configured to feed the recycled fiber material in form of fiber slivers or fiber bundles to a spinning machine of the spinning unit. The direct feeding of recycled fiber slivers (without or with an intermediate drawing procedure) to the spinning machine provides a very much simplified workflow, in that hitherto necessary procedures, including preparatory steps for bale pressing, bale pressing itself, bale transportation, and then subsequent bale opening and carding at a spinning mill are no longer necessary and can be eliminated.

In embodiments, the drawing unit can comprise at least one of: a card dover module for concentrating or bundling the recycled fiber flow or fiber fleece or fiber mat into a recycled fiber sliver or fiber bundle; a drawing station, in particular integrated auto-leveling drawing system, for drawing and/or equalizing the recycled fiber sliver or fiber bundle; and a can filling station, in particular automatic can coiler, for canning the drawn recycled fiber sliver or fiber bundle, which may be called a finisher sliver. Herein, the sliver production, i.e. fiber bundling and fiber bundle drawing, provides an intermediate product, typically a finisher sliver, which is suitable for immediate feeding into a subsequent stage or step of the integrated recycling, drawing and spinning machine and method, which however is unsuitable or at least less favourable for transportation compared to conventionally bale-pressed recycled fiber material. This is in contrast to conventional recycling machines, which output recycled fiber material in form of bales to allow for their transportation to different locations, typically to spinning mills.

In embodiments, the spinning unit can comprise at least one of: a spinning machine, in particular rotor spinning machine, for open-end spinning the sliver into a yarn; a spinning machine, in particular compact ring spinning machine with integrated roving drawing frame, for drafting the (e.g. canned) recycled fiber sliver or fiber bundle into a roving and for spinning the roving into a yarn; a sliver mixing draw frame for mixing the recycled fiber slivers or fiber bundles among themselves for improving fiber homogeneity; a sliver mixing draw frame for mixing the recycled fiber slivers or fiber bundles with virgin fiber material for improving fiber quality. While spinning as such is well-known, the combination of recycling with the drawing procedure and the spinning procedure, in particular when including roving drafting, provides substantial technical improvement, logistic simplification and economic savings over the conventionally known separately operated processes.

In embodiments, at least one or each fine opener line can be integrated at its downstream side with an assigned drawing station, in particular auto-leveling drawing system (briefly IGS), of the drawing unit for drawing and/or equalizing the recycled fiber sliver. In further embodiments, at least one or each drawing station comprises an assigned can filling station, in particular automatic can coiler.

In embodiments, each card doffer module can be equipped with an integrated auto-leveling drawing system (IGS) to feed clean, carded fiber sliver into an attached automatic can filling station or can coiler.

In yet further embodiments, at least one or each can filling station, in particular automatic can coiler, can be connected to an assigned or a common can exchange and/or transfer station and/or to a sliver mixing draw frame for at least one of: providing first, typically larger cans and/or second, typically smaller cans for filling or refilling them; providing cans with virgin fiber material for mixing it with the recycled fiber material, in particular with the recycled fiber sliver; transferring the first and/or second cans to the spinning machine. Herein, refilling may relate inter alia to filling cans again after use, i.e. after emptying; or to filling smaller cans for the spinning machine with recycled fiber sliver from larger cans from the can filling station of the drawing unit.

In embodiments, the first or large cans may have diameters e.g. in a range of 120 cm to 150 cm, as used e.g. for conventional carding machines, whereas the second or small cans may have diameters e.g. in a range of 50 cm to 60 cm, which fit for spinning machines, such as open-end rotor spinning machines or ring spinning machines, e.g. equipped with a roving drawing frame and compactor system (briefly called compact ring spinning machines).

In embodiments, the can exchange and/or transfer station can comprise a can conveyor system: (i) for delivering filled cans from the at least one or each can filling station to the spinning machine and/or the sliver mixing draw frame ; and/or (ii) for re-delivering empty cans from the spinning machine and/or the sliver mixing draw frame to the at least one or each can filling station; and/or (iii) for circulating mixed-fiber cans from the sliver mixing draw frame to the spinning machine and empty cans from the spinning machine to the sliver mixing draw frame.

If several fine opener lines are present, they are preferably arranged in parallel. Herein, assigned means that the assigned devices are provided specifically in a one-to-one correspondence to one another. Thus, each fine opener line can be equipped with its own drawing station, its own can filling station, and/or its own can exchange and/or transfer station. This has the advantage that the fine opener lines can be operated independently from one another, and that a number of fine opener lines can be operated in parallel such that their combined production capacity for canned intermediate products, such as canned drawn recycled fiber slivers, can be matched to the spinning capacity of the spinning machine, in particular when taking into account mixing of the recycled natural fiber material with an additional amount of virgin natural fiber material.

In embodiments, the recycling unit comprises one fiber opener line equipped with a buffer container for producing and collecting, in particular intermediately storing, pre-opened textile fiber material, the buffer container is connected via feed ducts to one or more, e.g. three, fine opener lines in parallel, each fine opener line is connected at its downstream side to an assigned card dover module, an assigned drawing station, in particular integrated auto-leveling drawing system, and an assigned can filling station, in particular automatic can coiler, for delivering the drawn recycled fiber slivers or fiber bundles to the spinning unit, in particular open-end rotor spinning machine or ring spinning machine with integrated roving drawing frame, with or without sliver mixing draw frame.

In embodiments, exactly one fine opener line can be directly connected to the preceding one fiber opener line, even without a buffer container.

In embodiments, the production capacities of the recycling unit, the drawing unit and the spinning unit, in particular yarn spinning capacity of the open-end rotor spinning machine or of the ring spinning machine equipped with a roving drawing frame, can be adapted to one another.

In embodiments, a production capacity of the fiber opener line and/or a storage capacity of a buffer container, a number and production capacity of the one or more parallel fine opener lines, and a production capacity of the drawing unit, in particular of card dover module(s), drawing station(s) or integrated auto-leveling drawing system(s) and can filling station(s) or automatic can coiler(s), can be matched to a production capacity of the spinning unit, in particular open-end rotor spinning machine or ring spinning machine with integrated roving drawing frame, with or without sliver mixing draw frame.

In embodiments, the sliver mixing draw frame can comprise: a sliver feeding system for feeding recycled-fiber sliver from first supply cans and optionally natural-fiber sliver from second supply cans, a sliver drawing and mixing system for homogenizing and/or mixing the slivers, and a canning system for filling the homogenized and/or mixed sliver into second cans for delivery to the spinning machine.

In embodiments, the sliver mixing draw frame can comprise a can conveyor system for transporting second cans filled with mixed sliver to the spinning machine and for transporting empty second cans from the spinning machine back to the sliver mixing draw frame.

In embodiments, the recycling unit can comprise at least one of: an integrated carding station; and an integrated extraction module, in particular electrostatic and/or mechanic extraction module, for extracting synthetic fiber material from mixed textile waste fiber material containing synthetic fiber material and natural fiber material. Preferably, each fine opener line comprises at least one such integrated extraction module, in particular electrostatic and/or mechanic extraction module, for extracting synthetic fiber material from mixed textile waste fiber material containing synthetic fiber material and natural fiber material. Such refinement stages of steps may be present at any adequate part of the integrated recycling, drawing and spinning machine and method.

In embodiments, the recycling unit does not comprise at least one of: a fiber air-suction system for fiber transportation to a baling press; a baling-press condenser; a baling-press container; a baling press for pressing recycled textile fiber material; and a chemical fiber treatment unit.

In embodiments, the integrated drawing and spinning unit does not comprise at least one of: a bale opener for opening bales of recycled textile fiber material; a carding machine for carding bale-opened recycled textile fiber material.

In embodiments, the textile waste material can comprise natural fiber material containing at least one of: cotton fiber, hemp fiber, linen fiber, ramie fiber, sisal fiber, bamboo fiber, silk fiber, and mixtures thereof. In other embodiments, the textile waste material may comprise synthetic fiber material containing at least one of: polyester fiber, polyurethane fiber, Elastane fiber, polyamide fiber, viscose or rayon fiber, acrylic fiber, nylon fiber, and mixtures thereof.

In another aspect, the invention relates to a method for integrated recycling and spinning of textile waste materials into a yarn, in particular by using the integrated recycling and spinning machine as disclosed herein, the method comprising the method steps of:
a. recycling textile waste materials into recycled fiber material in a recycling unit,
b. feeding the recycled fiber material in form of a fiber flow or fiber fleece or fiber mat to a drawing unit and drawing the recycled fiber material, in particular into a fiber sliver, and
c. manufacturing in a spinning unit a yarn containing the recycled fiber material.

The integrated method of recycling textile waste material and manufacturing yarn containing the recycled textile waste fiber material has the advantages as outlined above, in particular technical improvement, logistic simplification, and economic savings over conventional recycling lines and conventional spinning mills located in different sites and operated in an independent and uncoordinated manner.

In embodiments, step a. can comprise at least one of: cutting textile waste in a cutter; pre-opening the fiber waste material in a fiber opener line to obtain pre-opened fiber material; fine-opening the pre-opened fiber material in a fine opener line to obtain the recycled fiber material; and extracting in an integrated extraction module, in particular electrostatic and/or mechanic extraction module, synthetic fiber material from mixed textile waste fiber material containing the synthetic fiber material and natural fiber material.

In embodiments, step b. can comprise at least one of: receiving the fiber flow or fiber fleece or fiber mat from a fine opener line of the recycling unit; concentrating or bundling the recycled fiber flow or fiber fleece or fiber mat into a recycled fiber sliver or fiber bundle in a card dover module of the drawing unit; drawing the recycled fiber sliver or fiber bundle in a drawing station, in particular integrated auto-leveling drawing system, of the drawing unit; canning the drawn recycled fiber bundle in a can filling station, in particular automatic can coiler, of the drawing unit.

In embodiments, step c. can comprise at least one of: mixing the drawn recycled fiber sliver with virgin fiber material in a sliver mixing draw frame; spinning the sliver into a yarn in a rotor spinning machine; drafting the drawn recycled fiber sliver into a roving and spinning the roving into a yarn in a ring spinning machine. In embodiments, an operation and a production capacity of the recycling unit, in particular of the parallel fine opener lines, and of the drawing unit and the spinning unit are matched to one another.

In embodiments, the method does not comprise at least one step of: air-sucking recycled textile fiber material in a fiber air-suction system towards a baling press; condensing the recycled textile fiber material in a baling-press condenser; collecting the recycled textile fiber material in a baling-press container; pressing the recycled textile fiber material into bales in the baling press; transporting bales containing the recycled textile fibers to another location, in particular to a spinning mill; carding the bale-pressed textile fiber material in a carding machine.

In embodiments, the method does not comprise at least one step of: opening bales containing recycled textile fiber material in a bale opener; carding the bale-opened recycled textile fiber material in a carding machine.

It is to be understood that both the foregoing general description and the following detailed description present embodiments with optional features, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain in examples the principles and operation of the concepts disclosed herein.

### BRIEF DESCRIPTION OF THE DRAWINGS

The herein described invention will be more fully understood from the detailed description given herein below and the accompanying drawings which show or relate to exemplary embodiments only and shall not be construed to be limiting to the invention claimed in the appended claims. The drawings show schematically in:

FIG. 1-2 a prior art recycling line in perspective and top view, equipped with a hydraulic bale press for pressing the recycled fiber material into bales for subsequent transportation to a spinning mill;

FIG. 3 a prior art carding machine and rotor spinning machine in a spinning mill;

FIG. 4 an integrated recycling and spinning machine with a drawing unit for producing fiber sliver and a spinning unit in a perspective view, according to an embodiment of the invention;

FIG. 5 the integrated recycling and spinning machine of FIG. 4 in top view;

FIG. 6 an integrated recycling and spinning machine with can transfer station to the spinning unit in a perspective view, according to another embodiment of the invention;

FIG. 7 the integrated recycling and spinning machine of FIG. 6 in top view;

FIG. 8 an integrated recycling and spinning machine with can transfer station and sliver mixing draw frame in a perspective view, according to another embodiment of the invention;

FIG. 9 the sliver mixing draw frame from FIG. 8 in a detailed perspective view; and

FIG. 10 the sliver mixing draw frame of FIG. 9 in top view.

### DESCRIPTION OF THE EMBODIMENTS

Reference will now be made in detail to certain embodiments, examples of which are illustrated in the accompanying drawings, in which some, but not all features are shown. Embodiments disclosed herein may be embodied in many different forms, may include variations in one or more features or aspects, and may in general be combined with one another. Embodiments should not be construed as being limiting; rather, these embodiments are provided to assure that this disclosure will satisfy applicable legal requirements. In general, same reference numbers shall refer to same or similar components or parts.

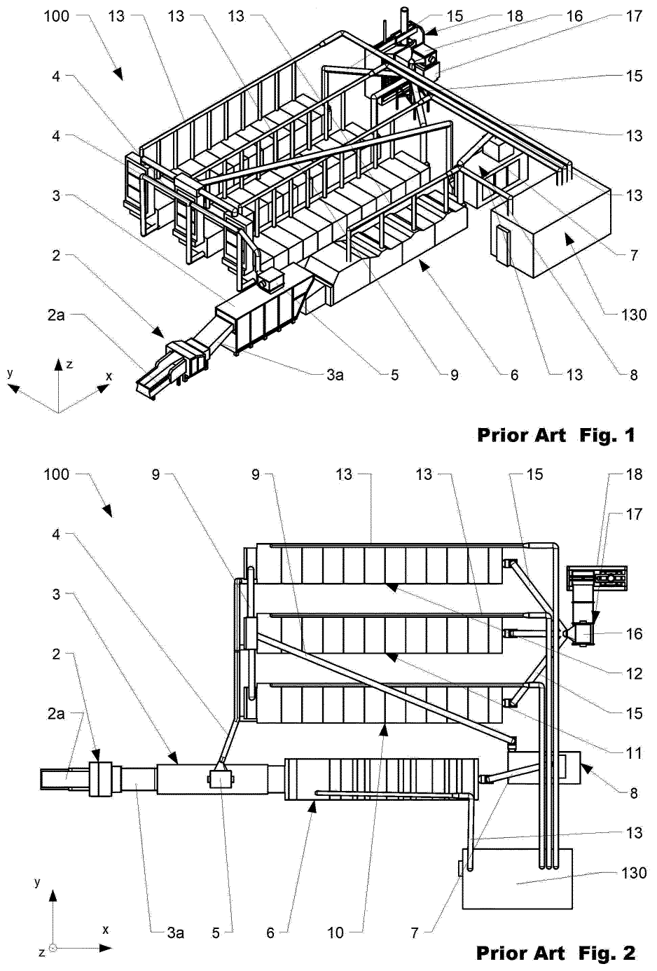

FIGS. 1 to 2 show a schematic perspective and top view of a prior art textile recycling machine 100. Textile waste material, such as clothes waste or yarn waste, is transported on a transportation band 2a to a cutter 2. The cut textile waste is transported on a further transportation band 3a to a first buffer container 3 for intermediate storage of the textile cuts or shreds or yarn waste. The first buffer container 3 can also be fed with leftovers, e.g. unopened or insufficiently opened textile fiber materials, which are collected via air ducts 4 from the fine opening stages 10, 11, 12 and guided back to the first condenser 5. The first buffer container 3 feeds its content e.g. via another transportation band to the first fiber opener line 6, which pre-opens the fibers contained in the cut textile waste material for obtaining single, not yet fully parallel fibers. The pre-opened fiber material is collected via a feed duct 7 and transported to a second buffer container 8 for intermediate storage. The second container 8 feeds its content via feed ducts 9 to three fine opener lines 10, 11, 12. The feed ducts 9 are typically implemented in form of a fiber air-suction feeding system. In the fine opener lines 10, 11, 12 the textile fiber material is fine-opened to obtain recycled textile fiber material of sufficient quality, typically canning quality. The first fiber opener line 6 and the subsequent fine opener lines 10, 11, 12 are usually equipped with sucking or vacuum-driven filter air ducts 13 connected to a filter 130 for collecting and filtering fiber waste material, such as very short fiber fragments or dust, originating from the fiber opening processes. The recycled textile fiber material is then collected via air ducts 15, condensed in a second condenser 16, stored in a container 17, and then pressed into bales in a baling press 18. The second condenser 16 serves for separating the fibers from the air stream, alike a sieve, such that the fibers can fall into the container 17. Typically, some 200 kg to 300 kg of recycled textile fiber material is pressed into one bale. The conventional recycling machine 100 and recycling method thus starts from bales of clothes waste and/or yarn waste and results in bales of recycled textile fiber material for subsequent transportation for further processing.

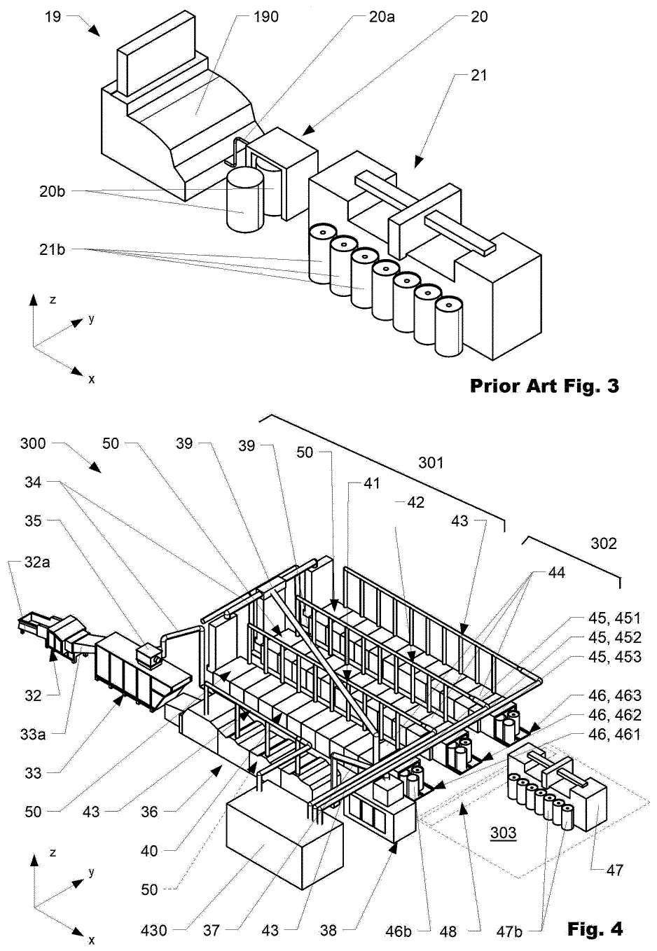

FIG. 3 shows a schematic perspective view of a conventional carding machine 19, can filling station 20 and rotor spinning machine 21, which are located in a separate site, e.g. a spinning mill, to which the bales of recycled textile fiber material must be transported. The bales must be opened in a bale opener (not shown) and then the recycled fiber material must be carded in the separate carding machine 19 for re-straightening and cleaning the recycled textile fiber material after having been condensed in the second condenser 16 and pressed together in the baling press 18 and for recovering or improving the quality of the recycled textile fiber material. Thus, the separate carding stage 19 largely serves for compensating the adverse effect of bale-pressing on the fiber quality of the recycled textile fiber material.

The carding machine 19 typically comprises a draw frame 190 for producing a recycled fiber sliver, which is fed via a can filling duct 20a to the can filling station 20 for being filled into first larger cans 20b. The canned sliver can be mixed with virgin fiber material and be refilled into second smaller cans 21b. The second cans 21b provide the sliver to the rotor spinning machine 21.

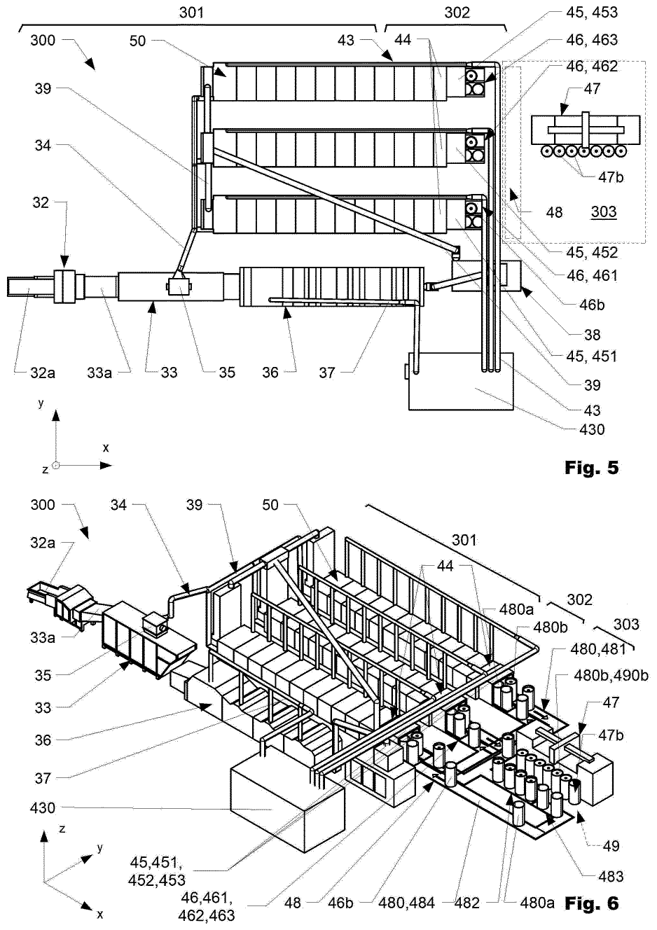

FIG. 4 and FIG. 5 show embodiments of an integrated recycling and spinning machine 300 of the invention, which in particular comprises a recycling unit 301, a drawing unit 302 and a spinning unit 303.

The recycling unit 301 is different in various respects from the prior art recycling machine 100 described above. Textile waste material, such as clothes waste, industrial textile waste or yarn waste, can be transported on a transportation band 32a to a cutter 32, which may include rotating drums, a guillotine or other cutting means. The cut textile waste can be transported on a further transportation band 33a to a first buffer container 33 for intermediate storage of the textile cuts or shreds or yarn waste. The first buffer container 33 can also be fed with leftovers, such as unopened or insufficiently opened textile fiber materials, which are recollected via air ducts 34 from the fine opening stages 40, 41, 42 and guided back to the condenser 35. The condenser 35 serves for separating the fibers from the air stream, alike a sieve, such that the fibers can fall into the first buffer container 33. The first buffer container 33 feeds its content, such as clothes cuts or industrial textile shreds or yarn waste, e.g. via another transportation band to the first fiber opener line 36, which pre-opens the fibers contained in the cut textile waste material for obtaining single fibers. Such single fibers are typically not yet fully parallel and still inhomogeneously distributed. The pre-opened fiber material can be collected via a feed duct 37 and transported to a second buffer container 38 for intermediate storage. The second buffer container 38 can feed its content via feed ducts 39 to for example three fine opener lines 40, 41, 42. The feed ducts 39 can typically be implemented in form of a fiber air-suction feeding system. In the fine opener lines 40, 41, 42 the textile fiber material can be fine-opened to obtain recycled textile fiber material of sufficient quality, typically canning quality. The first fiber opener line 36 and the subsequent fine opener lines 40, 41, 42 can preferably be equipped with sucking or vacuum-driven filter air ducts 43 connected to a filter 430 for collecting and filtering fiber waste material, such as very short fiber fragments or dust, originating from the fiber opening processes. According to the invention, the integrated recycling and spinning machine 300 comprises also a drawing unit 302 for producing a sliver, in particular recycled-fiber sliver. Embodiments hereof are schematically shown in FIG. 4 and FIG. 5 and are discussed below.

The drawing unit 302 can comprise a card dover module 44 and/or a drawing station, in particular auto-leveling drawing system, 45, 451, 452, 453, preferably for each fine opener line 40, 41, 42, which are arranged in parallel to one another and in sequence with the foregoing pre-opener fiber line 36. Each card dover module 44 receives an endless fiber flow or fiber fleece or fiber mat extended in two planar dimensions, i.e. length and width dimension, as delivered from its assigned foregoing fine opening stage 40, 41, 42, and concentrates this into a rather round recycled fiber bundle or recycled fiber sliver suitable for canning. As a numerical example, the fiber flow or fleece or mat may have a typical width of about 1 m to 1.5 m and a typical height of about 5 mm to 50 mm and is concentrated or bundled into a relatively round recycled fiber sliver having a diameter of about 30 mm. This recycled fiber sliver can be made to have canning quality. The recycled fiber sliver may correspond in terms of fiber quality, in particular including fiber lengths and fiber orientations, to a conventional card sliver conventionally obtained from recycled textile fiber material after bale opening in a bale opener and carding in a carding machine 19, as explained in the context of FIGS. 1 to 3. However, in the present disclosure there is no need for a fiber air-suction system 15, baling-press condenser 16, baling-press container 17, baling press 18, bale transportation means (not shown), bale opener (not shown), and separate carding machine 19 for re-stratifying bale-opened recycled textile fiber material.

The drawing stations, in particular integrated auto-leveling drawing systems, 451, 452, 453 serve for drawing and/or equalizing the recycled fiber sliver, thereby producing a drawn recycled fiber sliver of improved fiber homogeneity. One, several or each drawing station 451, 452, 453 can comprise e.g. a breaker draw frame, which produces a recycled fiber breaker sliver, and/or a finisher draw frame, which produces a recycled fiber finisher sliver. The sliver quality and homogeneity is thereby increased such that the drawn recycled fiber sliver becomes useful for a subsequent yarn spinning process, and optionally for a roving drafting and yarn spinning process.

The drawing unit 302 can further comprise a can filling station 46, e.g. automated can coiler 46, preferably a can filling station 461, 462, 463 for each fine opener line 40, 41, 42. The can filling stations 461, 462, 463 serve for canning the drawn recycled fiber sliver into cans, in particular first cans or large cans 46b.

As shown in FIGS. 4 to 8, the can filling stations, e.g. automated can coiler, 46; 461, 462, 463 can further each or jointly be connected to a can exchange and/or transfer space 48 and optionally to a sliver mixing draw frame 49 for operator-handled, semi-automated or fully automated actions comprising at least one of: exchanging first, typically larger cans 46b and/or second, typically smaller cans 47b for filling them or refilling them or for refilling from first cans 46b into second cans 47b; providing further supply cans 490d with virgin fiber material or virgin fiber sliver for mixing it with the recycled fiber material, in particular with the recycled fiber sliver, in the mixing station 49; transferring the smaller cans 47b to the spinning machine 47. In particular, the second smaller cans 47b are adapted in size for providing the recycled and optionally mixed fiber sliver to each spinning station of the spinning machine 47. For example, the first large cans 46b have diameters in a range of 120 cm to 150 cm. For example, the second small cans 47b have diameters in a range of 50 cm to 60 cm.

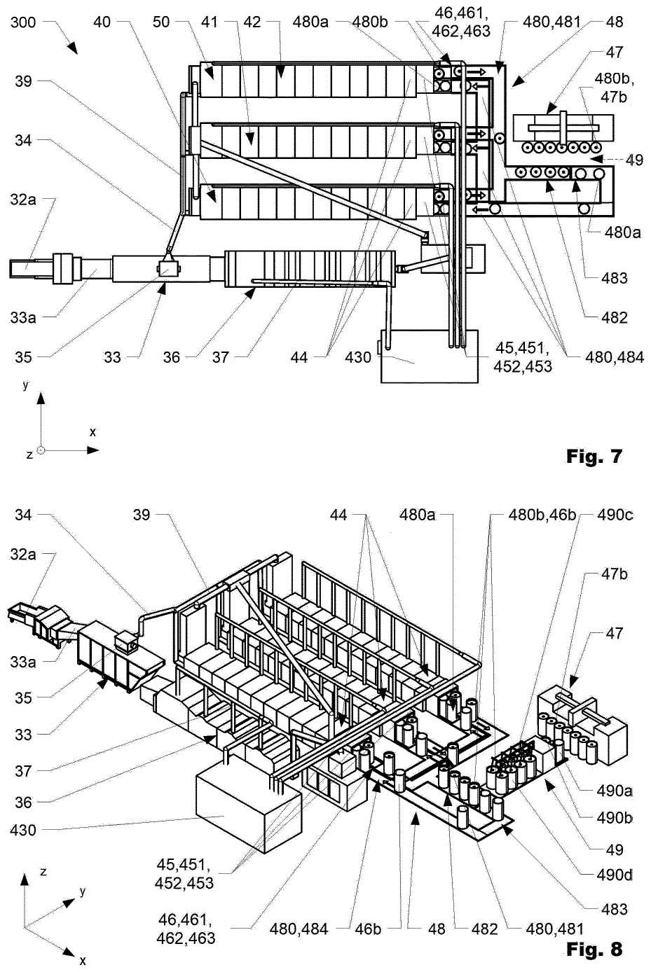

FIGS. 6 and 7 show in more detail the integrated recycling and spinning machine 300 of FIGS. 4 and 5, additionally equipped with an automated can exchange and/or transfer station 48 or can transport system 48. The can exchange and/or transfer station 48 can comprise a can conveyor system 480, e.g. a forward conveyor belt 481, for delivering filled cans 480b from the at least one or each can filling station 461, 462, 463 to a can delivery space 482 of the spinning machine 47; and a can conveyor system 480, e.g. backward conveyor belt 484, for re-delivering empty cans 480a from a can removal space 483 of the spinning machine 47 to the at least one or each can filling station 461, 462, 463. Alternatively or in addition, the refilling of recycled fiber sliver and/or mixing with virgin fiber material and/or moving of cans 47b between the drawing unit 302, in particular can filling station 46, and the spinning machine 47, can be done by personnel or can involve manual procedural steps performed by personnel.

FIG. 8 shows in more detail the integrated recycling and spinning machine 300 of FIGS. 6 and 7, additionally equipped with a sliver mixing draw frame 49 for mixing fiber materials of different quality, in particular virgin or natural fiber material and the recycled fiber material (fiber blend mixing draw frame), or for homogenizing or further homogenizing the recycled fiber material among itself. Herein, the can exchange and/or transfer station 48 can comprise a can conveyor system 480, e.g. a forward conveyor belt 481, for delivering filled cans 480b from the at least one or each can filling station 461, 462, 463 to a can delivery space 482 of the sliver mixing draw frame 49; and a can conveyor system 480, e.g. backward conveyor belt 484, for re-delivering empty cans 480a from a can removal space 483 of the fiber mixing station 49 to the at least one or each can filling station 461, 462, 463.

The sliver mixing draw frame 49 is used (FIGS. 8 to 10) or is avoided (FIGS. 6 to 7) depending on technical criteria, in particular: (i) the obtained quality of the recycled fiber sliver, (ii) optionally producing an improved quality of the recycled fiber sliver by mixing-in virgin fiber sliver, (iii) the quality of the yarn to be produced therefrom, and (iv) the requirements on sliver cohesion or stability for the selected drawing and spinning units 302, 303 or drawing and spinning method steps.

For example, the recycled fiber sliver may comprise relatively short fibers, which when excessively drawn or parallelized in a draw frame 49 could result in low cohesion or even breakage of the fiber sliver, and/or which may be made more cohesive or stable by mixing-in relatively long virgin fibers. Another criterion for using or not using a draw frame 49 can be, that open-end rotor yarn spinning can be operated with fiber sliver having less cohesion or stability compared to ring yarn spinning with integrated roving drawing frame and roving compactification or condensing, which requires fiber sliver having more cohesion or stability.

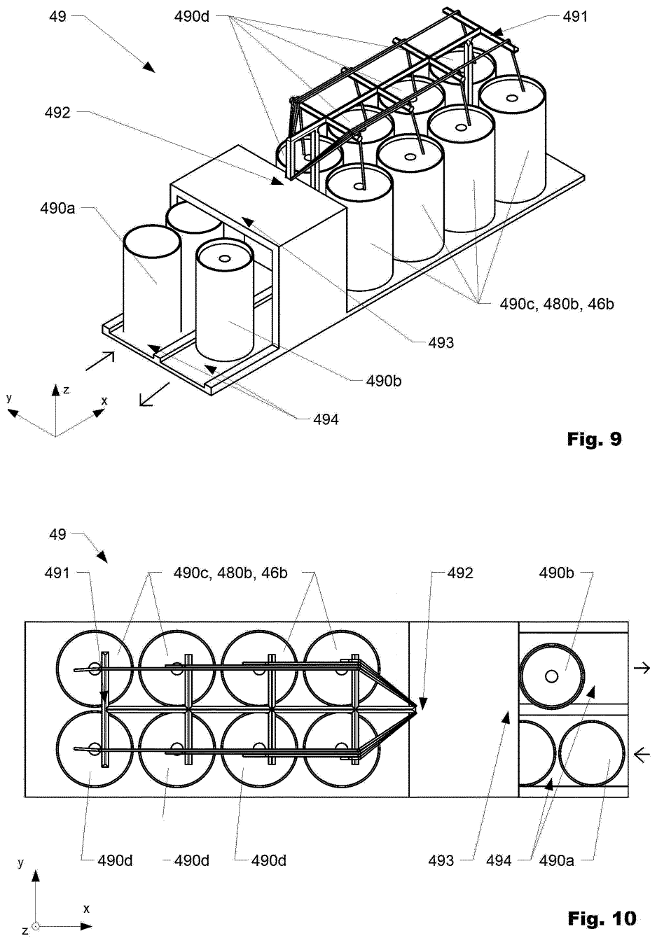

FIGS. 9 and 10 show the sliver mixing draw frame 49 in more detail. It can comprise a sliver mixing draw frame 491, 492, 493, 494 comprising: a sliver feeding system 491 for feeding recycled-fiber sliver from first supply cans 490c and optionally virgin-fiber or natural-fiber sliver from second supply cans 490d, a sliver drawing and mixing system 492 for homogenizing and/or mixing the slivers, and a canning system 493 for filling the homogenized and/or mixed sliver into second cans 490b, 47b for delivery to the spinning machine 47. The first supply cans 490c can be filled with the recycled-fiber sliver from the filled cans 480b from the can filling station(s) 46; 461, 462, 463; or it can be the filled cans 480b. The second supply cans 490d can be delivered from external.

In addition, the sliver mixing draw frame 49 can comprise a can conveyor system 494 for transporting the second cans 490b filled with the mixed sliver to the spinning machine 47 and for transporting the empty second cans 490a from the spinning machine 47 back to the sliver mixing draw frame 49.

The spinning unit 303 comprises at least one spinning machine 47, which can manufacture yarn directly from or comprising the canned recycled fiber sliver, i.e. the recycled fiber sliver having canning quality.

Throughout this application, the spinning machine 47 can comprise or be a rotor spinning machine 47 for open-end rotor spinning the sliver into a yarn. Furthermore, the spinning machine 47 can comprise or be a ring spinning machine 47 with integrated roving drawing frame for drafting the fiber sliver into a roving and for spinning the roving into a yarn; in particular, the spinning machine 47 can comprise or be a ring spinning machine equipped with a roving drawing frame and optionally a compactor system (briefly compact ring spinning machine). Such a compact ring spinning machine is e.g. disclosed in the unpublished international patent application PCT/EP2022/067075 with the title “Ring spinning machine for spinning yarn”, the content of which, including the figures, is herewith enclosed in this disclosure in its entirety by reference.

In addition, the spinning machine 47 can comprise, as mentioned before, the sliver mixing draw frame 49 for mixing the recycled fiber slivers among themselves for improving the fiber homogeneity, and/or can comprise the sliver mixing draw frame 49 for mixing the recycled fiber slivers with natural or virgin fiber material for improving the fiber quality. For example in the case of cotton material, recycled textile fiber material can be mixed with virgin fiber material in a selectable ratio.

As an alternative or in addition to the mixing station(s) 49, one, several or each fine opener line 40, 41, 42 can also comprise a number of cascaded fine-opening stages for refining the recycled textile fiber material to achieve a recycled fiber sliver of canning quality directly, i.e. without mixing with virgin fiber material, such that the spinning machine 47, typically rotor spinning machine 47, can produce yarn of sufficient quality for weaving, knitting or the like from 100% recycled textile fiber sliver.

In another aspect, the invention also relates to a method for integrated recycling and spinning of textile waste materials into a yarn, the method comprising the method steps of:
a. recycling textile waste materials into recycled fiber material in a recycling unit 301,
b. feeding the recycled fiber material in form of a fiber flow or fiber fleece or fiber mat to a drawing unit 302 and drawing the recycled fiber material into a fiber sliver; and
c. manufacturing in a spinning unit 303 a yarn containing the recycled fiber material.

Embodiments of the method relate to using the integrated recycling and spinning machine 300 as disclosed herein. Embodiments of the method are also disclosed in the summary of the application and in the appended method claims.

The integrated recycling and spinning machine 300 can further comprise additional stations, such as e.g. at least one integrated extraction module 50, in particular electrostatic and/or mechanic extraction module 50, preferably at least one integrated extraction module 50 for each fine opener line 40, 41, 42, as schematically indicated in FIGS. 4 to 8.

The integrated extraction module 50 can be positioned preferably between two parts or in a first part or at the beginning of the or each fine opener line 40, 41, 42; and/or in addition in the first fiber opener line 36. The integrated extraction module 50 serves for extracting synthetic fiber material from mixed textile waste fiber material containing synthetic fiber material and natural fiber material. In embodiments, several integrated extraction modules 50 may also be arranged in sequence to remove synthetic fiber material in several subsequent steps with increased purity.

The integrated extraction module 50 may be of any conventional type, e.g. involving electrostatic extraction means for separating synthetic fiber material from natural fiber material having different electrical conductivity and/or involving mechanical means for supporting such electrostatic extraction means. Preferably, the integrated extraction module 50 does not comprise chemical and/or enzymatic fiber treatment means, which may involve wet processes.

In embodiments, the integrated extraction module 50 may also be of an innovative type, as disclosed in co-pending unpublished international patent application PCT/EP2023/061681 of the same applicant with the title “Electrostatic separation device for elastic mono filaments from cotton staple fiber yarns in fleeces”, the content of which, including the figures, is herewith enclosed in this disclosure in its entirety by reference.

In particular, the integrated extraction module 50 serves for extracting synthetic fiber material from mixed textile waste fiber material containing synthetic fiber material and natural fiber material and for this purpose may comprise:
a. an electrostatic charging unit that is configured to be mountable at the integrated recycling and spinning machine 300, in particular at the recycling unit 301, and serves for electric charging a fiber fleece of mixed textile fiber material and/or for moving charged synthetic fiber material closer to a surface of the fleece, and
b. a separation stage comprising separation means for removing a layer, in particular surface layer, of the fiber fleece containing an increased or decreased concentration of the synthetic fiber material.

The integrated extraction module corresponds to the extraction module as disclosed in the above-mentioned international patent application, wherein the textile recycling machine is replaced by the recycling unit 301 of the integrated recycling and spinning machine 300 as disclosed herein.

In embodiments, the electrostatic charging unit may be configured to be mounted, in particular retrofitted, at a fine opening stage 40, 41, 42 of the recycling unit 301. In further embodiments, the separation means comprise electrical separation means for applying an electric separation field to the charged fiber fleece for moving or further moving the charged synthetic fiber material closer to the surface of the fleece. In further embodiments, the electrical separation means comprise electrodes for applying the electric separation field to the charged fiber fleece and/or comprises an electric roller or an electrostatic conveyor belt for electric charging the synthetic fiber material and/or electrically attracting the charged synthetic fiber material. In further embodiments, the separation means comprise mechanical fiber-treatment means for treating the charged fiber fleece in order to further move the charged synthetic fiber material closer to the surface of the fleece, in particular when exposed to the electrostatic separation field. In embodiments, the separation means comprise mechanical separation means that are configured to remove a surface layer containing an increased concentration of the synthetic fiber material; and/or to remove an opposite surface layer or a volume layer of the natural fiber material containing a decreased concentration of the synthetic fiber material. The separation means may be selected from the group of: tee roller, knife, skiving tool, knock-off toll, brush, brush roller, grate, or combinations thereof.

In another aspect of the embodiments relating to the integrated extraction module 50, the method for integrated recycling and spinning of textile waste materials into a yarn can comprise an extraction method for extracting synthetic fiber material from a fleece of mixed textile waste fiber material containing a synthetic fiber material and a natural fiber material, the extraction method comprising the extraction method steps of:
a. exposing the fleece to an electrostatic charging field provided by an electrostatic unit for electrostatic charging the synthetic fiber material in the fleece,
b. applying an electrostatic separation field provided by electric field-generating means for providing a movement direction of the charged synthetic fiber material towards a surface layer of the fleece,
c. mechanically treating the fleece by mechanical fiber-treatment means for promoting movement of the charged synthetic fiber material towards the surface layer of the fleece, in particular when the fleece is exposed to the electrostatic separation field, and
d. removing a layer containing an increased or decreased concentration of the synthetic fiber material by separation means, in particular mechanical separation means.

Embodiments may comprise in step d.: removing a surface layer containing an increased concentration of the synthetic fiber material by electric separation means; and/or removing an opposite surface layer or a volume layer of the natural fiber material containing a decreased concentration of the synthetic fiber material by mechanical separation means.

In embodiments of the integrated extraction module 50 or extraction method, the fleece of mixed textile waste fiber material contains the synthetic fiber material in an initial concentration range of at most 10%, preferred at most 5%, more preferred at most 3%, more preferred at most 2%; and/or the fleece of mixed textile waste fiber material comprises or consists of core-yarn textile waste fiber material; and/or wherein the fleece does not contain blended-fabrics textile waste fiber material.

Embodiments thereof may comprise an additional method step of repeating at least one of: the combined steps a. and b. or the step c. or the step d. or a combination thereof, until the recycled natural fiber is obtained in a quality that is sufficient for reuse in a fiber spinning process. Further embodiments of the extraction method relate to using the integrated extraction module 50 as disclosed herein or in the referenced international patent application PCT/EP2023/061681.

Throughout this application, natural fiber material is or contains cellulose fiber material, such as e.g. cotton fiber, hemp fiber, linen fiber, ramie fiber, sisal fiber, bamboo fiber, or mixtures thereof. Cellulose fibers have important advantages such as low density, low cost, they are recyclable and are biodegradable. The natural fiber material may also be or contain silk fiber.

As discussed, the textile wastes may contain mixtures of natural and synthetic fibers which may require the integrated extraction module 50 or extraction method steps. For example, textiles can contain core yarn having a synthetic continuous filament forming the stretchable core and natural fiber roving providing volume to the core. Examples of synthetic fiber materials are polyester fiber, polyurethane fiber, Elastane fiber, polyamide fiber, viscose or rayon fiber, acrylic fiber, nylon fiber.

Throughout the integrated recycling and spinning machine and method as disclosed herein, further or intermediate or other refinement manufacturing steps are possible and shall be encompassed in the integrated recycling and spinning machine 300 and method.

### LIST OF REFERENCE SIGNS

100 prior art textile recycling machine
2 cutter for textile waste, rotating drums, guillotine
2a transportation band for textile waste (clothes waste, industrial textile waste, yarn waste)
3 buffer container for textile cuts or shreds, first buffer container
3a transportation band for textile cuts or shreds or yarn waste
4 air ducts for unopened or insufficiently opened textile fiber material
5 condenser (for recollected unopened textile fiber material), first condenser
6 fiber opener line, first fiber opener line, fiber pre-opener line
7 feed duct (to second buffer), feed duct for collecting pre-opened textile fiber material
8 buffer container for pre-opened textile fiber material, second buffer container
9 feed ducts (to fine opener lines), feed ducts for distributing pre-opened textile fiber material, fiber air-suction feeding system
10 first fine opener line
11 second fine opener line
12 third fine opener line
13 filter air ducts
130 filter
15 air duct for collecting recycled textile fiber material, fiber air-suction system towards baling press
16 condenser (for recycled textile fibers), baling-press condenser, second condenser
17 container (for collecting recycled textile fibers), baling-press container
18 baling press (for recycled textile fibers)
19 carding machine (after bale opener)
190 draw frame
20 can filling station
20a can filling duct
20b (large) cans, first cans
21 spinning machine, rotor spinning machine
19-21 carding and spinning machine, spinning mill
21b (small) cans, second cans
300 integrated recycling and spinning machine
301 recycling unit
302 drawing unit
303 spinning unit
302, 303 drawing and spinning unit
32 cutter for textile waste, rotating drums, guillotine
32a transportation band for textile waste (clothes waste, industrial textile waste, yarn waste)
33 buffer container for textile cuts or shreds, first buffer container
33a transportation band for textile cuts or shreds or yarn waste
34 air ducts for unopened textile fiber material
35 condenser (for recollected unopened textile fiber material)
36 fiber opener line, first fiber opener line, fiber pre-opener line
37 feed duct (to second buffer), feed duct for collecting pre-opened textile fiber material
38 buffer container for pre-opened textile fiber material, second buffer container
39 feed ducts (to fine opener lines), feed ducts for distributing pre-opened textile fiber material, fiber air-suction feeding system
40 first fine opener line
41 second fine opener line
42 third fine opener line
43 filter air ducts
430 filter
44 card dover module
45 (integrated) drawing station, draw frame, breaker draw frame, finisher draw frame, integrated auto-leveling drawing system (IGS),
451 first drawing station (for first fine opener line), first IGS
452 second drawing station (for second fine opener line), second IGS
453 third drawing station (for third fine opener line), third IGS
46 can filling stations, large-can filling stations, can supply stations, automatic can coiler
461 first can filling station (for first fine opener line)
462 second can filling station (for second fine opener line)
463 third can filling station (for third fine opener line)
46b cans, large cans, first cans
47 spinning machine, rotor spinning machine, ring spinning machine with integrated roving drawing frame, compact ring spinning machine
47b cans, small cans, second cans
480a first cans, empty cans
480b second cans, filled cans
48 can transportation space, can exchange and/or transfer space (operator-handled and/or automated); can exchange and/or transfer station, automatic can transport system, can refilling station (e.g. from large cans to small cans)
480 can conveyor system, bidirectional can conveyor belt (between can filling stations and spinning machine), filled can delivery system (to spinning machine), empty can re-delivering system (to can filling station)
481 forward conveyor belt (for full cans)
482 can delivery space (for spinning machine and/or sliver mixing station)
483 can removal space (for empty cans from spinning machine and/or sliver mixing station)
484 can re-delivering system (for empty cans)
49 draw frame, fiber blend mixing draw frame, sliver mixing draw frame
490a first cans, empty cans
490b second cans, mixed-fiber cans, 47b
490c first supply cans, large cans, recycled-fiber cans, 46b
490d second supply cans, large cans, natural-fiber cans
491 sliver feeding system
492 sliver drawing system, sliver mixing system
493 mixed-sliver canning system
494 can transport system, can conveyor belt
50 integrated extraction module (for separating synthetic fibers from natural fibers), electrostatic and/or mechanic extraction module

1. An integrated recycling and spinning machine for manufacturing yarn from textile waste, comprising:
a. a recycling unit that is configured to recycle textile waste material into recycled fiber material, and that is integrated with
b. a drawing unit and a spinning unit that are configured to manufacture a yarn containing the recycled fiber material.

2. The integrated recycling and spinning machine of claim 1, wherein the recycling unit comprises a cutter for textile waste, a fiber opener line and at least one fine opener line for obtaining the recycled fiber material.

3. The integrated recycling and spinning machine of claim 1, wherein the recycling unit comprises several fine opener lines in parallel, and some or all of the fine opener lines are configured to feed the recycled fiber material in the form of a recycled fiber sliver to a spinning machine of the spinning unit.

4. The integrated recycling and spinning machine of claim 1, wherein the drawing unit comprises at least one of: a card dover module for concentrating the recycled fiber flow or fleece or mat into a recycled fiber sliver; a drawing station, in particular an integrated auto-leveling drawing system, for drawing and/or equalizing the recycled fiber sliver; and a can filling station, in particular an automatic can coiler, for canning the drawn recycled fiber sliver.

5. The integrated recycling and spinning machine of claim 1, wherein the spinning unit comprises at least one of: a spinning machine, in particular a rotor spinning machine, for open-end spinning the sliver into a yarn; a spinning machine, in particular a compact ring spinning machine with an integrated roving drawing frame, for drafting the recycled fiber sliver into a roving and for spinning the roving into a yarn; a sliver mixing draw frame for mixing the recycled fiber slivers among themselves for improving fiber homogeneity; a sliver mixing draw frame for mixing the recycled fiber slivers with virgin fiber material for improving fiber quality.

6. The integrated recycling and spinning machine of claim 1, wherein at least one or each fine opener line is integrated at its downstream side with an assigned drawing station in of the drawing unit for drawing and/or equalizing the recycled fiber sliver.

7. The integrated recycling and spinning machine of claim 1, wherein at least one or each drawing station comprises an assigned can filling station.

8. The integrated recycling and spinning machine of claim 1, wherein at least one or each can filling station is or are connected to an assigned or a common can exchange and/or transfer station and/or to a sliver mixing draw frame for at least one of: providing first cans and/or second cans for filling or refilling them; providing cans with virgin fiber material for mixing it with the recycled fiber material transferring the first and/or second cans to the spinning machine.

9. The integrated recycling and spinning machine of claim 8, wherein the can exchange and/or transfer station comprises a can conveyor system; (i) for delivering filled cans from the at least one or each can filling station to the spinning machine and/or the sliver mixing draw frame; and/or (ii) for re-delivering empty cans from the spinning machine and/or the sliver mixing draw frame to the at least one or each can filling station; and/or (iii) for circulating mixed-fiber cans from the sliver mixing draw frame to the spinning machine and empty cans from the spinning machine to the sliver mixing draw frame.

10. The integrated recycling and spinning machine of claim 1, wherein the recycling unit comprises one fiber opener line equipped with a buffer container for producing and collecting pre-opened textile fiber material, the buffer container is connected via feed ducts to one or more parallel fine opener lines, each fine opener line is connected at its downstream side to an assigned card dover module, an assigned drawing station and an assigned can filling station for delivering the drawn recycled fiber slivers to the spinning unit with or without sliver mixing draw frame.

11. The integrated recycling and spinning machine of claim 1, wherein a production capacity of the fiber opener line and/or a storage capacity of a buffer container, a number and production capacity of the one or more parallel fine opener lines, and a production capacity of the drawing unit are matched to a production capacity of the spinning unit with or without sliver mixing draw frame.

12. The integrated recycling and spinning machine of claim 8, wherein the sliver mixing draw frame comprises: a sliver feeding system for feeding recycled-fiber sliver from first supply cans and optionally natural-fiber sliver from second supply cans, a sliver drawing and mixing system for homogenizing and/or mixing the slivers, and a canning system for filling the homogenized and/or mixed sliver into second cans for delivery to the spinning machine.

13. The integrated recycling and spinning machine of claim 8, wherein the sliver mixing draw frame comprises a can conveyor system for transporting second cans filled with mixed sliver to the spinning machine and for transporting empty second cans from the spinning machine back to the sliver mixing draw frame.

14. The integrated recycling and spinning machine of claim 1, wherein the recycling unit or each fine opener line further comprises at least one integrated electrostatic and/or mechanic extraction module, for extracting synthetic fiber material from mixed textile waste fiber material containing synthetic fiber material and natural fiber material.

15. The integrated recycling and spinning machine of claim 1, wherein the recycling unit does not comprise at least one of: a fiber air-suction system for fiber transportation to a baling press; a baling-press condenser; a baling-press container; a baling press for pressing recycled textile fiber material; a chemical fiber treatment unit.

16. The integrated recycling and spinning machine of claim 1, wherein the integrated drawing and spinning unit does not comprise at least one of: a bale opener for opening bales of recycled textile fiber material; a carding machine for carding bale-opened textile fiber material.

17. The integrated recycling and spinning machine of claim 1, wherein the textile waste material comprises natural fiber material containing at least one of: cotton fiber, hemp fiber, linen fiber, ramie fiber, sisal fiber, bamboo fiber, silk fiber, and mixtures thereof.

18. The integrated recycling and spinning machine of claim 1, wherein the textile waste material comprises synthetic fiber material containing at least one of: polyester fiber, polyurethane fiber, Elastane fiber, polyamide fiber, viscose or rayon fiber, acrylic fiber, nylon fiber, and mixtures thereof.

19. A method for integrated recycling and spinning of textile waste materials into a yarn, the method comprising the method steps of:
a. recycling textile waste materials into recycled fiber material in a recycling unit
b. feeding the recycled fiber material in the form of a fiber flow or fiber fleece or fiber mat to a drawing unit and drawing the recycled fiber material into a fiber sliver; and
c. manufacturing in a spinning unit yarn containing the recycled fiber material.

20. The method of claim 19, wherein step a. comprises at least one of: cutting textile waste in a cutter; pre-opening the fiber waste material in a fiber opener line to obtain pre-opened fiber material; fine-opening the pre-opened fiber material in a fine opener line to obtain the recycled fiber material; and extracting in an integrated electrostatic and/or mechanic extraction module synthetic fiber material from mixed textile waste fiber material containing the synthetic fiber material and natural fiber material.

21. The method of claim 19, wherein step b. comprises at least one of: receiving the fiber flow or fiber fleece or fiber mat from a fine opener line of the recycling unit; concentrating the recycled fiber flow or fiber fleece or fiber mat into a recycled fiber sliver in a card dover module of the drawing unit; drawing the recycled fiber sliver in a drawing station, in particular an integrated auto-leveling drawing system, of the drawing unit; canning the drawn recycled fiber sliver in a can filling station, in particular an automatic can coiler, of the drawing unit.

22. The method of claim 19, wherein step c. comprises at least one of: mixing the drawn recycled fiber sliver with virgin fiber material in a sliver mixing draw frame; spinning the sliver into a yarn in a rotor spinning machine; drafting the drawn recycled fiber sliver into a roving and spinning the roving into a yarn in a ring spinning machine.

23. The method of claim 19, wherein an operation and a production capacity of the recycling unit, or of the parallel fine opener lines and of the drawing unit and the spinning unit are matched to one another.

24. The method of claim 19, wherein the method does not comprise at least one step of: air-sucking recycled textile fiber material in a fiber air-suction system towards a baling press; condensing recycled textile fiber material in a baling-press condenser; collecting recycled textile fiber material in a baling-press container; pressing recycled textile fiber material into bales in the baling press; transporting bales containing the recycled textile fiber material to another location, in particular to a spinning mill; carding bale-pressed textile fiber material in a carding machine; opening bales containing recycled textile fiber material in a bale opener; carding the bale-opened recycled textile fiber material in a carding machine.

25. (canceled)
